(19) United States
(12) Patent Application Publication
(10) Pub. No.: US 2008/0047399 A1
(43) Pub. Date: Feb. 28, 2008

(54) Twisting-force spanner with a function of identifying a specification of the spanner

(76) Inventor: Chih-Ching Hsieh, Taichung (TW)

Correspondence Address: Chih-Ching Hsieh, 235 Chung - Ho, Box 8-24, Taipei, omitted

(21) Appl. No.: 11/511,066

(22) Filed: Aug. 28, 2006

(51) Int. Cl. B25B 23/16; B25G 1/00

(52) U.S. Cl. 81/177.1

(57) ABSTRACT

A twisting-force spanner with a function of identifying a specification of the spanner; the spanner having a tight ring at a handle thereof for identification of a specification of the spanner by a color of the tight ring. Red color, orange color, yellow color, green color, blue color and purple color represent that maximum twisting forces allowable to be applied by the spanner are 80 lb, 90 lb, 100 lb, 110 lb, 120 lb, and 130 lb, respectively. The tight ring has numbers representing allowable twisting force. The tight ring has numbers representing allowable twisting force. The tight ring is coated with fluorescent material. The number is formed by fluorescent material or is colored.

### FIELD OF THE INVENTION

The present invention relates to spanners, and in particular to a twisting-force spanner with a function of identifying a specification of the spanner, wherein the user can identify the specification of the spanner by a tight ring enclosing the handle easily without needing the taking every spanner. Moreover, the tight ring can be retained for a very long time without lose.

### BACKGROUND OF THE INVENTION

A tire used twisting spanner has generally different specifications about the twisting force they can be applied so as to suit the size of the tire to be driven.

In one prior art twisting spanner for locking a tire has a handle and a driving head. The user can hold the handle to apply a force to the spanner.

However in use of this kind of twisting spanner, the user must select a suitable one according to the twisting force allowable (pound number). Thus the user must take every spanner for determining whether the spanner is an allowable one. This makes an inconvenient to the users.

In another prior art spanner, the head is colored for identification.

However the head is easy to wear because it must contact with the screw means and thus the color is decay or even disappear. It is not a suitable design.

In another prior art, an indication is installed in the handle for displaying the pound number of the spanner, but the indication is not apparent. It is only viewed at some orientation of the spanner. Thereby it is not effective in identification of the specification of the spanner.

### SUMMARY OF THE INVENTION

Accordingly, the primary object of the present invention is to provide a twisting-force spanner with a function of identifying a specification of the spanner, wherein the user can identify the specification of the spanner by the tight ring enclosing the handle easily without needing the taking every spanner. Moreover, the tight ring can be retained for a very long time without lose.

To achieve above objects, the present invention provides a twisting-force spanner with a function of identifying a specification of the spanner; the spanner having a tight ring at a handle thereof for identification of a specification of the spanner by a color of the tight ring. Red color, orange color, yellow color, green color, blue color and purple color represent that maximum twisting forces allowable to be applied by the spanner are 80 lb, 90 lb, 100 lb, 110 lb, 120 lb, and 130 lb, respectively. The tight ring has numbers representing allowable twisting force. The tight ring has numbers representing allowable twisting force. The tight ring is coated with fluorescent material. The number is formed by fluorescent material.

The various objects and advantages of the present invention will be more readily understood from the following detailed description when read in conjunction with the appended drawing.

### BRIEF DESCRIPTION OF THE DRAWINGS

FIG. 1 is a perspective view of the present invention.

FIG. 2 is a schematic perspective view of the present invention.

FIG. 3 is a schematic view showing the use of the present invention.

FIGS. 4 and 5 are schematic views showing the different examples of the present invention, where different colors represent different specification.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

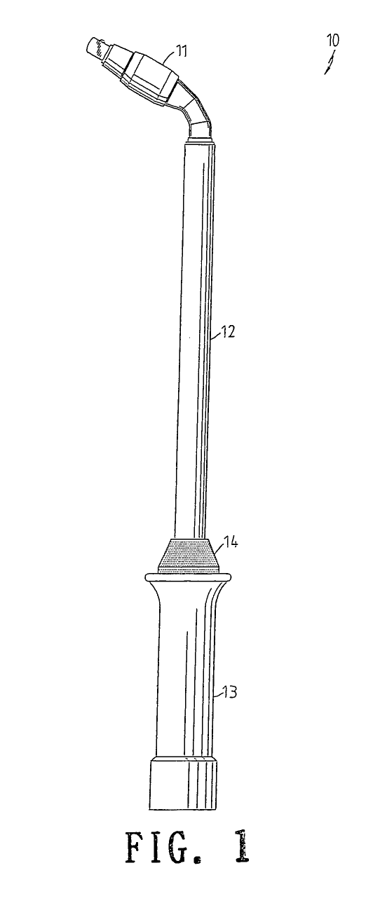

Referring to FIG. 1, the structure of the present invention is illustrated. The twisting spanner of the present invention has the following elements.

A spanner 10 has a driving head 11, a rod portion 12 and a handle 13.

The driving head 11 is engageable with a spanner 10 or other hand tool for driving or screwing a screw unit 22.

The rod portion 12 is a long rod axially extends from the handle 13 of the spanner 10. The rod portion 12 is connected between the driving head 11 and the handle 13. A length of the rod portion 12 can provide a sufficient arm-of-force as the driving head 11 drives a screw unit 22.

The handle 13 can be held by a user. A tight ring 14 is installed on the handle 13. The color of the tight ring 14 is specific for identification. Spanner 10 of different specification has a tight ring 14 of different color. Thus the user can identify the spanner 10 easily.

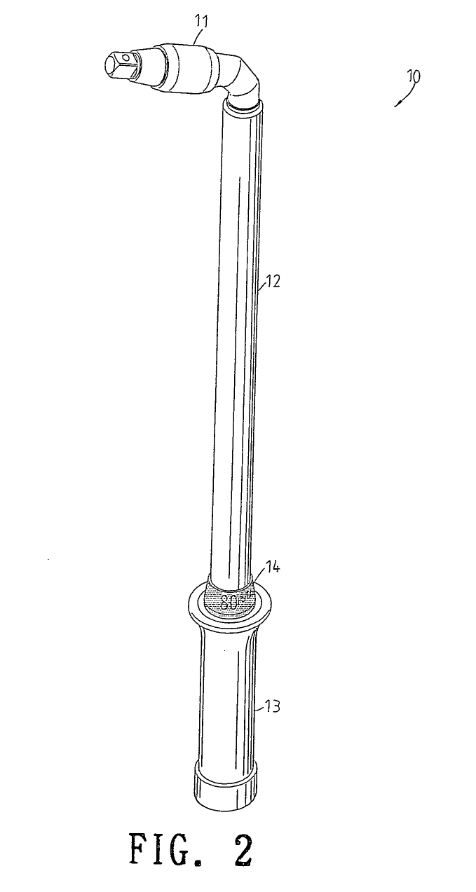

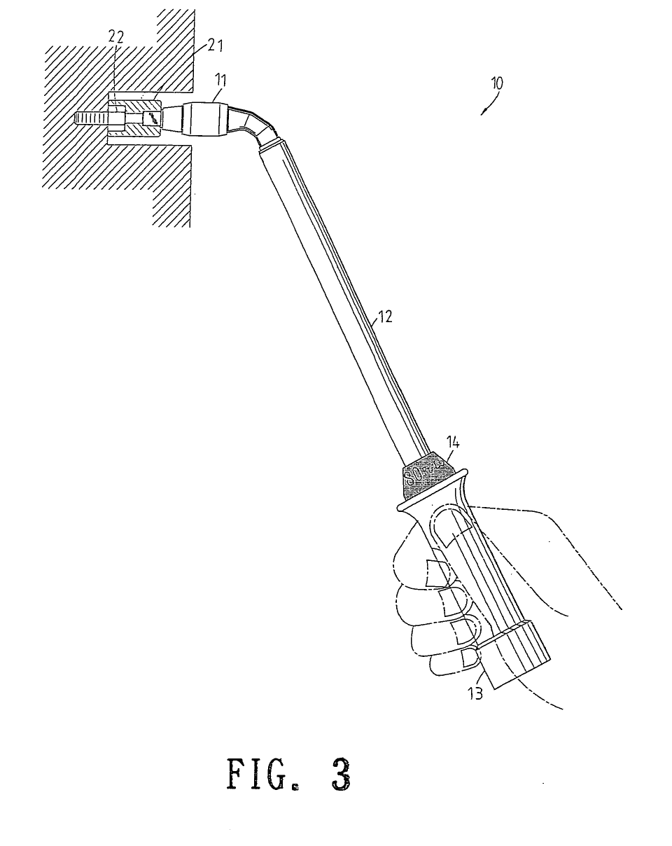

The tight ring 14 can have texture or symbol for identifying the specification of the spanner 10. As shown in FIG. 2, the tight ring 14 is indicated with a specification of 80 ft/lb (foot pound), that is, the spanner 10 can apply a maximum twisting force of 80 pounds.

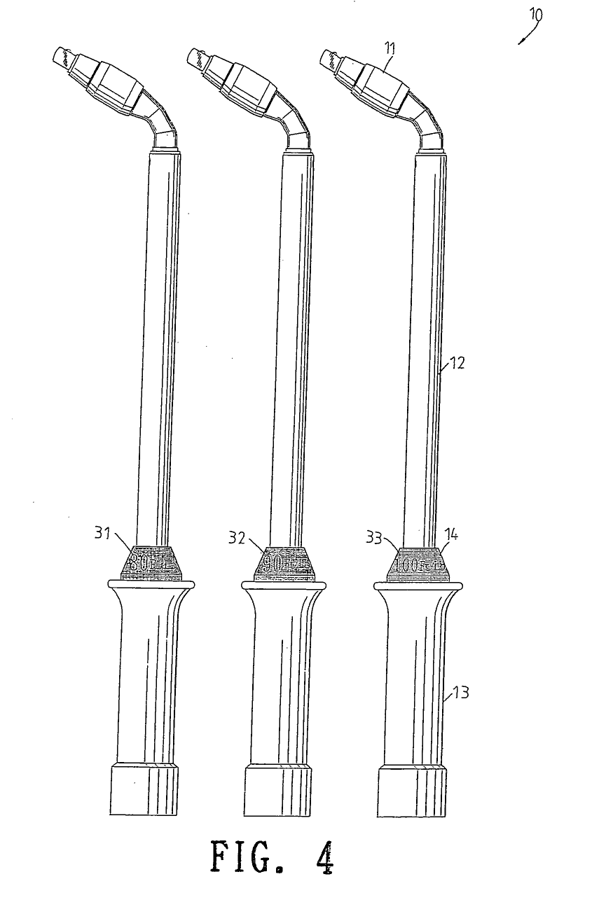

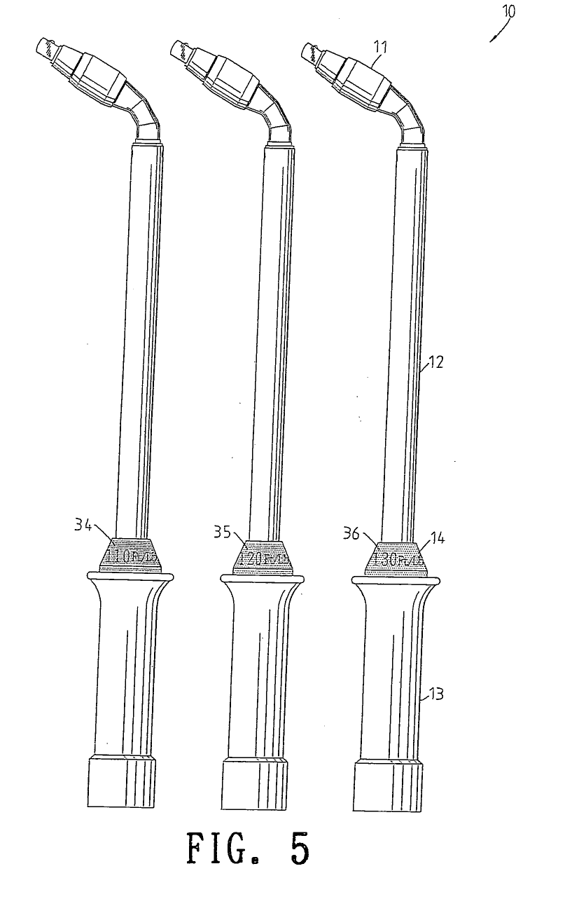

Referring to FIGS. 4 and 5, it is illustrated that the tight ring 14 has different color. When in use, the user can select a desired spanner by the color of the tight ring 14. Thus, the user does not need to take every spanner for identifying the specification of the spanner 10.

In this embodiment, a red color 31 represents that the maximum twisting force allowable in the spanner is 80 lb (pounds); an orange color 32 represents that the maximum twisting force allowable in the spanner is 90 lb (pounds); a yellow color 33 represents that the maximum twisting force allowable in the spanner is 100 lb (pounds); a green color 34 represents that the maximum twisting force allowable in the spanner is 110 lb (pounds); a blue color 35 represents that the maximum twisting force allowable in the spanner is 120 lb (pounds); and a purple color 36 represents that the maximum twisting force allowable in the spanner is 130 lb (pounds).

However above mentioned colors are not used to confine the scope of the present invention. The pounds (twisting forces) are also not confined by above example. Other colors and pounds are permissible.

Furthermore, the indications on the tight ring 14 can be made by materials such as fluorescent light materials. Thus, the user can identify the indications easily. Or the number of the color on the tight ring 14 has colors different from those of the tight ring 14 so as to make the user identify the indication easily from the colors.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A twisting-force spanner with a function of identifying a specification of the spanner; the spanner having a tight ring at a handle thereof for identification of a specification of the spanner by a color of the tight ring.

2. The twisting-force spanner with a function of identifying a specification of the spanner as claimed in claim 1, wherein red color, orange color, yellow color, green color, blue color and purple color or the combination of theses colors represent that maximum twisting forces allowable to be applied by the spanner are 80 lb, 90 lb, 100 lb, 110 lb, 120 lb, and 130 lb.

3. The twisting-force spanner with a function of identifying a specification of the spanner as claimed in claim 1, wherein red color, orange color, yellow color, green color, blue color and purple color represent that maximum twisting forces allowable to be applied by the spanner are 80 lb, 90 lb, 100 lb, 110 lb, 120 lb, and 130 lb, respectively.

4. The twisting-force spanner with a function of identifying a specification of the spanner as claimed in claim 1, wherein the tight ring has numbers representing allowable twisting force.

5. The twisting-force spanner with a function of identifying a specification of the spanner as claimed in claim 1, wherein the tight ring is coated with fluorescent material.

6. The twisting-force spanner with a function of identifying a specification of the spanner as claimed in claim 4, wherein the number is formed by fluorescent material.

7. The twisting-force spanner with a function of identifying a specification of the spanner as claimed in claim 4, wherein the number is formed with different color.
